(19) United States
(12) Patent Application Publication
(10) Pub. No.: US 2021/0406870 A1
(43) Pub. Date: Dec. 30, 2021

(54) CRYPTOCURRENCY MINING METHOD AND SYSTEM

(71) Applicants: Yury MAYORAU, ag. Kirovskaya (BY); Denys SLIUSAREV, Zaperizhia (UA)

(72) Inventors: Yury MAYORAU, ag. Kirovskaya (BY); Denys SLIUSAREV, Zaperizhia (UA)

(21) Appl. No.: 16/916,527

(22) Filed: Jun. 30, 2020

(51) Int. Cl. G06Q 20/36; G06Q 40/00

(52) U.S. Cl. CPC G06Q 20/367; G06Q 2220/10; G06Q 40/12

(57) ABSTRACT

The present invention involves implementing a passive mechanism for creating new cryptocurrency tokens by a user of the cryptocurrency. The invention further avoids the need for the creation of new blocks to receive tokens. The invention allows users to make a profit and participate in the growth of the system without being required to maintain a system node. By lowering the threshold for entering into beneficial status via use of a cryptocurrency, it reduces the risk to users, as the user's account automatically creates new tokens that at least partially compensate for losses in case of depreciation, or ideally provides a profit in case of the cryptocurrency's value growth or stability. The volatility of the currency is partially compensated and decentralization is increased via creation of new tokens by many accounts, each account having some balance, instead of providing tokens only to those users forging blocks.

### FIELD OF THE INVENTION

This invention relates to the field of cryptocurrency and particularly to methods and systems for maintaining and growing a cryptocurrency network.

### BACKGROUND OF THE INVENTION

Cryptocurrency mining relates to the mining of digital currencies and creating blocks in a blockchain employing mathematical calculations performed on high power computers (i.e., Proof Of Work—PoW). Alternatively, such mining may employ statistical analysis that takes into account the user's balance (i.e., Proof of Stake—PoS). Through the mining process, new tokens are formed in the cryptocurrency system as rewards for creating new blocks.

Forging relates to receiving a commission from a payment and creating a block on the blockchain, using similar tools as those used for mining; however, in forging, the Proof Of Stake (PoS) mechanism is most often used. Through the forging process, a commission is taken by a forger from fees paid by users of the system to perform transactions, wherein the commission is the reward for creating new blocks.

The present invention addresses disadvantages of both mining and forging processes and provides a solution in the form of a novel process for mining cryptocurrency which is neither mining nor forging.

### SUMMARY OF THE INVENTION

The present invention describes methods for implementing a passive mechanism for creating new cryptocurrency tokens by a user of cryptocurrency (“paramining”) while avoiding the need for creating new blocks by that user. This allows cryptocurrency users to receive a profit and participate in the growth of the system without the requirement of maintaining a system node, and without spending unnecessary time or money.

The aforementioned lowers the threshold for entering into a use (i.e. creating and funding an account) of cryptocurrency for inexperienced users, and it reduces the risk of losing a user's investment due to a depreciation. The user's account automatically creates new tokens that at least partially compensate for losses in case of depreciation, or even provide a profit in cases of the cryptocurrency's value growing or at least remaining stable. Thus, the volatility of the currency is partially compensated and decentralization is increased due to the creation of new tokens by many accounts, each account having some balance, instead of only providing new tokens to creators of the blocks of the system.

### BRIEF DESCRIPTION OF THE DRAWINGS

The present invention will now be discussed in further detail below with reference to the accompanying figures, briefly described as follows:

FIG. 1. An exemplary hierarchy of accounts, where accounts B and C are uplinked to account A, and account A is uplinked to 0. “Uplink” and “Downlink” terms are selected relative to account A.

FIG. 2. An exemplary hierarchy of account A, in layers, as a part of a global genesis account's hierarchy.

FIG. 3. An exemplary visualization of a complete account hierarchy. In the example, account A contains 2 accounts per single layer, and 88 total layers connected via downlinks.

FIG. 4. A visualization of the real paramining amount growth over time based on OPA and CPA. In the area until the intersection of OPA and CPA curves, a fine is associated with any attempted transaction that would trigger paramining, as described herein. The intersection point of OPA and CPA curves is the most profitable time to trigger paramining emissions. Ideally, an account should continue to paramine following the compound curve according to the rules described herein. The “holds” discussed herein are employed such that paramining emissions occurring prior to the intersection do not occur.

### DETAILED DESCRIPTION OF PREFERRED EMBODIMENTS

In the following description, for purposes of explanation, specific examples are set forth to provide a thorough understanding of the present invention. However, it will be apparent to one skilled in the art that these specific details are not required in order to practice the present invention. The same techniques can easily be applied to related systems and methods.

### Definitions

“Blockchain height,” as used herein, is defined as the count (i.e. amount) of blocks currently existing on a blockchain.

“Genesis account,” as used herein, is defined as an account which is the source of all tokens in the currency system. All newly created tokens are generated in and sent from the genesis account. The balance module of the genesis account is equal to total system emission.

“Paramining emission,” as used herein, is defined as a transaction from the genesis account, transferring new tokens, to the account of the creator of the tokens.

A cryptocurrency's “current emission,” as used herein, is defined as the current total existing tokens amount (per emission).

A cryptocurrency's “maximum emission,” as used herein, is defined as the maximum possible amount of existing tokens of that cryptocurrency (per emission).

“Paramining trigger,” or “trigger,” as used herein, is defined as an event of a balance change (i.e. a balance-changing event) in a user account, e.g., an outgoing transaction from a user account, or an account receiving a fee paid by another user, the fee being treated as a reward for creating a block.

“Account link,” as used herein, is defined as a link that is created between accounts. For each account, there is required to be exactly one uplink and an unlimited number of downlinks. An uplink is established during the first transaction into an account. The first transaction, per account, associates that account with the sender of the first transaction. Traversing over uplinks always eventually leads to the genesis account, i.e., every account in the system is a part of the accounts tree. See FIG. 1.

“Account layers,” as used herein, are defined as hierarchical schemes of accounts between intermediate links, said intermediate links existing between accounts. For example, according to the scheme provided in FIG. 2.

“User account hierarchy amount,” as used herein, is defined as the sum of the balances of all accounts located in account layers 1 through 88 of a given user account, each account layer comprising one or more linked accounts (which are uplinked to/downlinked from) the user's account. As an example, see FIG. 3.

“Account multiplier” or “multiplier,” as used herein, is defined as a factor that determines the number of new tokens that may be created in one day (i.e. 24 hours) and received by a specific user account. Account multipliers are calculated based on the total balance of the user account and the user account's hierarchy amount.

“Paratax,” as used herein, is defined as a mathematically calculated percentage subtracted from a paramining payout. Paratax increases as the emission of the system approaches its maximum value. A Paratax value depends only on the current emission of the system. Paratax changes will dynamically follow emission growth, and Paratax progressively updates the mathematically calculated percentage when generating new tokens for all accounts. Paratax works more smoothly than, e.g., halving, as used in Bittoken. The maximum Paratax is 99%.

“Paramining amount,” as used herein, is defined as a calculated token count that a user account may emit for a period of time, ΔT. Paramining amount depends on the account balance, the timestamp of the last operation that changed the balance of that account, and the sum of the balances of all linked accounts within 88 layers of the account. An account's paramining amount represents an amount of virtual tokens existing only as a mathematical model, as described further herein). Said amount of virtual tokens may grow and is kept virtual until the next balance change event occurring within the account. After the next balance change event, the paramining amount of the account will reset to zero, and the amount of virtual tokens becomes real tokens via an automatic transaction initiated from the genesis account (i.e., a paramining emission occurs).

A “hold” or “holds,” as used herein, is/are defined as a mechanism(s) to prevent other users from changing an account's balance thus triggering a paramining emission, simply by making a small transaction to the account. Holds incentivize users to forge blocks and avoid preemptively triggering paramining emissions via, e.g., making minimal transactions to create a paramining trigger. Due to holds within the paramining algorithm, it is more profitable for users to trigger paramining emissions after a determined period of time, and not earlier, as described further herein.

In accordance with an aspect of the invention, there is provided a computer-implemented method for managing cryptocurrency, comprising providing user accounts to a plurality of users, each one of said user accounts being suitable for storing cryptocurrency tokens, each one of said user accounts initiating with a zero balance of cryptocurrency tokens, providing a genesis account, said genesis account generating a plurality of cryptocurrency tokens, responsive to a balance-changing event in any one of said user accounts, providing a paramining emission, said paramining emission causing a distribution of an amount of cryptocurrency tokens present within said genesis account at a time of said balance-changing event, said distribution comprising paramining amounts per user account, said paramining amounts being calculated individually for each one of said user accounts, each of said paramining amounts being calculated using two multiplied values, said two multiplied values comprising an account balance multiplier and a hierarchy amount multiplier, wherein each one of said user accounts receives a paramining amount equal to each one of said user accounts' balances multiplied by said two multiplied values, wherein all paramining amounts combine to equal said generated plurality of cryptocurrency tokens.

In some aspects of the invention, said paramining amounts per user account are paramining amounts per user account over a period of time, wherein said period of time is 24 hours.

In some aspects of the invention, said account balance multiplier is between 0.1 and 0.4.

In some aspects, said hierarchy amount multiplier is between 2.0 and 4.0.

In some aspects, the method further comprises providing a paratax, said paratax being applied to each one of said user accounts' paramining amounts, said paratax being calculated by dividing a cryptocurrency's current emission by said cryptocurrency's maximum emission.

In some aspects, said paratax is applied only to those ones of said user accounts located at a given blockchain height.

In some aspects, each of said user accounts' paramining amounts is further calculated using data comprising a timestamp of a most recent account balance-changing event, a current timestamp, and a paratax associated with said user account.

In some aspects, each of said user accounts' paramining amounts comprises dual preliminary values, a smaller one of which is provided as an account's true paramining amount.

In some aspects, said dual preliminary values comprise an ordinary paramining amount (OPA) and a compound paramining amount (CPA).

In some aspects, said OPA is calculated via the following relationship: OPA=(user account balance*days*account multiplier)−paratax, wherein days=ΔT/86,400, wherein ΔT=T−T₀, wherein T=a current time in seconds, and wherein T₀=a timestamp of a most recent balance-changing event.

In some aspects, said CPA is calculated via the following relationship: CPA=(user account balance*((1+compound multiplier)^{periods})−account balance)−(2*paratax), wherein compound multiplier=(account multiplier/(86,400/period duration), wherein periods=ΔT/a period duration, and wherein ΔT=T−T₀.

In some aspects, the method further comprises providing a hold, said hold being placed on a user account when said user account creates a block, and when said block's height is within a predetermined range below a given blockchain height, said hold storing any incoming transaction for said block's creation in a temporary balance of said user account.

In some aspects, said hold is removed when said user account makes an outgoing transaction, and wherein a transfer of the temporary balance to said user account's balance.

In some aspects, each one of said user accounts further comprises a hierarchy amount, said hierarchy amount comprising a combination of balances of downlinked accounts.

In some aspects, each of said user accounts comprises up to 88 layers of downlinked accounts.

In some aspects, each layer of said up to 88 layers comprises two or more separate downlinked accounts.

In some aspects, every paramining emission occurs without a fee payment.

In some aspects, each user account comprises exactly one uplink.

In some aspects, the invention comprises a system for managing cryptocurrency, the system including a memory for storing computer-readable program code and a processor for executing the computer-readable program code, the system comprising a platform for providing user accounts to a plurality of users, each one of said user accounts being suitable for storing cryptocurrency tokens, each one of said user accounts initiating with a zero balance of cryptocurrency tokens, a genesis account, said genesis account generating a plurality of cryptocurrency tokens for paramining emissions within said system, a trigger for each of said paramining emissions, said trigger initiating each of said paramining emissions in response to a balance-changing event in any one of said user accounts, said paramining emission causing a distribution of an amount of cryptocurrency tokens present from said genesis account at a time of said balance-changing event, a processor for determining portions of said distribution comprising paramining amounts per user account, said paramining amounts being calculated individually for each one of said user accounts, each of said paramining amounts being calculated using two multiplied values, said two multiplied values comprising an account balance multiplier and a hierarchy amount multiplier, said processor further providing paramining amounts equal to each one of said user accounts' balances multiplied by said two multiplied values, wherein all paramining amounts for the balance-changing event combine to equal said generated plurality of cryptocurrency tokens distributed from said genesis account.

In some aspects, the invention comprises a computer program product for managing cryptocurrency, the computer program product comprising a computer-readable medium having stored computer-readable program code for performing the steps of providing user accounts to a plurality of users, each one of said user accounts being suitable for storing cryptocurrency tokens, each one of said user accounts initiating with a zero balance of cryptocurrency tokens, providing a genesis account, said genesis account generating a plurality of cryptocurrency tokens, responsive to a balance-changing event in any one of said user accounts, providing a paramining emission, said paramining emission causing a distribution of an amount of cryptocurrency tokens present within said genesis account at a time of said balance-changing event, said distribution comprising paramining amounts per user account, said paramining amounts being calculated individually for each one of said user accounts, each of said paramining amounts being calculated using two multiplied values, said two multiplied values comprising an account balance multiplier and a hierarchy amount multiplier, wherein each one of said user accounts receives a paramining amount equal to each one of said user accounts' balances multiplied by said two multiplied values, wherein all paramining amounts combine to equal said generated plurality of cryptocurrency tokens.

The present invention is a technology, tokened “paramining,” comprising a system built into a blockchain that allows an account to accrue interest when a user associated with that account completes a transaction. The accrual of interest is performed according to the formulas described herein, according to the balance of the user, and according to other significant indicators, such as the balance of the structure of wallets under the user's wallet (i.e. linked accounts), total cryptocurrency emission, position in blockchain structure, and other indicators described herein.

In general, paramining can also be described as a method or system for creating new tokens by using existing tokens as proof of the right to create new tokens, similar to how the “stake” serves as proof of the right to create a block during forging.

The term, “paramining,” can also be applied to the process of accumulating seconds between account balance changes, because for every second between balance changing events, a certain number of tokens may be paramined. By accumulating such seconds between account balance changes, ΔT is increased, and in turn the paramining amount is also increased.

Paramining comprises a novel method and system for emitting new tokens based on existing tokens. The method involves creating tokens using other tokens on an account balance as the basis for the creation—more tokens on a balance result in more new tokens created. An emission event occurs every time an operation changes the balance of the wallet. New tokens will be emitted in the next block, regardless of who forges the block.

A paramining emission is implemented/triggered by the creation of any transaction and occurs without a fee, transferring the number of the new tokens from the genesis account balance to the balance of the account that created the tokens. This approach makes the emission transparent and clear to users because transactions from the genesis account are emissions. This approach also allows users to track a total amount of the system's emissions because a module of the negative balance of the genesis account will always equal the current number of existing tokens.

Paramining may further employ any known financial mathematical models and payment rules which are compatible with the technology described herein.

Calculation of an Account Multiplier.

Every account multiplier is the product of two multipliers—multiplier 1 (the account balance multiplier) and multiplier 2 (the hierarchy amount multiplier). Multiplier 1 is determined according to the total balance of the account, and multiplier 2 is determined based on the hierarchy amount.

The following table (Table 1) provides an example of a multiplier 1 map, according to the present invention:

TABLE 1
Multiplier 1, based on account balance.

| Balance range | Multiplier 1 |
|---|---|
| From 1 to 99 | 0.12% |
| From 1 00 to 999 | 0.14% |
| From 1 000 to 9 999 | 0.18% |
| From 10 000 to 49 999 | 0.21% |
| From 50 000 to 99 999 | 0.25% |
| From 100 000 to 499 999 | 0.28% |
| From 500 000 to 1 000 000 | 0.33% |
| Less then 1 or more than 1 000 000 | 0% |

The following table (Table 2) provides an example of a multiplier 2 map, according to the present invention.

TABLE 2
Multiplier 2, based on hierarchy amount.

| Hierarchy amount range | Multiplier 2 |
|---|---|
| From 1,000 to 9,999 | 2.18 |
| From 10,000 to 99,999 | 2.36 |
| From 100,000 to 999,999 | 2.77 |
| From 1,000 000 to 9,999,999 | 3.05 |
| From 10,000,000 to 99,999,999 | 3.36 |
| From 100,000,000 to 999,999,999 | 3.88 |
| More then 1,000,000,000 | 4.37 |

The resulting multiplier, which is calculated by multiplying multipliers 1 and 2 together, is the factor which leads to the amount of virtual tokens which an account may create in a period of 24 hours (i.e. one day).

Example 1. The following example is provided to illustrate the application of the account multiplier to calculate a basic virtual token 24 hour limit.

Account A has 500,000 tokens on its balance and 1,000,000 tokens as its hierarchy amount. Based on Tables 1 and 2, the account multiplier is equal to (0.33%)*(3.05)=1.0065%. The amount of basic virtual tokens per day allowed is then calculated by multiplying the account multiplier and the account balance: 1.0065%*500,000=5,032.5 virtual tokens per day are allowed for Account A.

Calculation of the Paratax.

To calculate the paratax, the cryptocurrency's current emission within the system is divided by the cryptocurrency's maximum emission (Paratax=current emission/maximum emission).

Example 2. The following example illustrates the application of the paratax to an exemplary account.

A cryptocurrency's current emission is 100,000 tokens. The cryptocurrency's maximum emission is 300,000 tokens. Therefore, the paratax of the system at blockchain height, H, is 100,000/300,000=33%. This paratax is a percentage of tokens which is removed from any account's paramining amount (i.e. virtual token count) just prior to each emission. Paratax is shared by all accounts involved in the paramining emission occurring at blockchain height, H. The paratax changes dynamically with each new block on the blockchain and progressively adjusts its percentage over the course of the system generating new tokens, with a goal of increasing the cryptocurrency's current emission.

Calculation of an Account's Paramining Amount.

The calculation of the paramining amount for an account requires the following data:
1. The balance of the account;
2. The timestamp of the most recent balance-changing event;
3. The current timestamp;
4. The account's hierarchy amount;
5. The account's current Paratax.

Dual versions (i.e. values) of paramining amount, i.e. two preliminary values per each moment in time, are calculated to prevent users from over-emitting tokens. The smaller of the two results is selected as the account's true paramining amount. Having two versions of paramining amount according to the formulas described herein significantly decreases any overly frequent or pre-emptive paramining emissions by users, thus increasing the rate of virtual token creation over time relative to a normal rate when only one value of paramining amount is provided. Thus, if a user attempts to trigger paramining emissions too often, that user will be creating fewer new tokens than potentially possible, due to the rules of the system, which is undesirable.

Example 3. The following example illustrates how an exemplary paramining amount is calculated, based on an exemplary user account.

The procedure for calculating the amount of paramining at time T for an account, A, is as follows.

First preliminary paramining amount calculation: Ordinary Interest Calculation. An account's ordinary paramining amount (OPA) is calculated by the following relationship: OPA=(user account balance*days*account multiplier)−paratax, where “days”=ΔT/86,400 (i.e. the number of seconds in a day), where ΔT=T−T₀, where T=current time in seconds, and T₀=timestamp of most recent balance change event.

Second preliminary paramining amount calculation: Compound Interest Calculation. An account's compound paramining amount (CPA) is calculated by the following relationship. CPA=(user account balance*((1+compound multiplier)^{periods})−account balance)−(2*paratax), where “compound multiplier”=(account multiplier)/(number of seconds per day/period duration)=multiplier/(86400/period duration), where “periods”=ΔT/period duration, where “period duration”=50 seconds (as an example), where ΔT=T−T₀, where T=current time in seconds, where T₀=timestamp of most recent balance change event.

A decision is made between the two curves resulting from the OPA and CPA formulas. If an OPA is greater then a CPA of the account, then the paramining amount equals the CPA (compound interest amount). If the OPA is lower than the CPA of the account, the account's paramining amount is the OPA (ordinary payout amount). The lower of the two values is always chosen by the system.

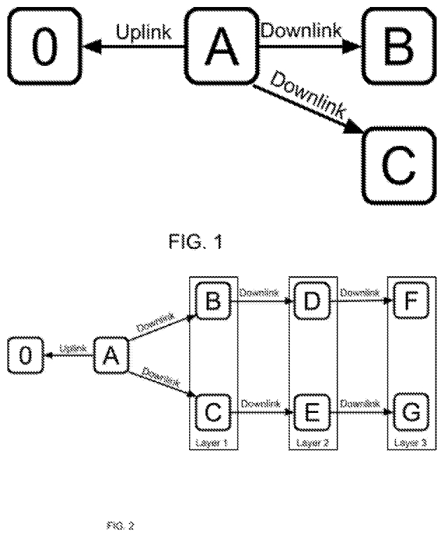

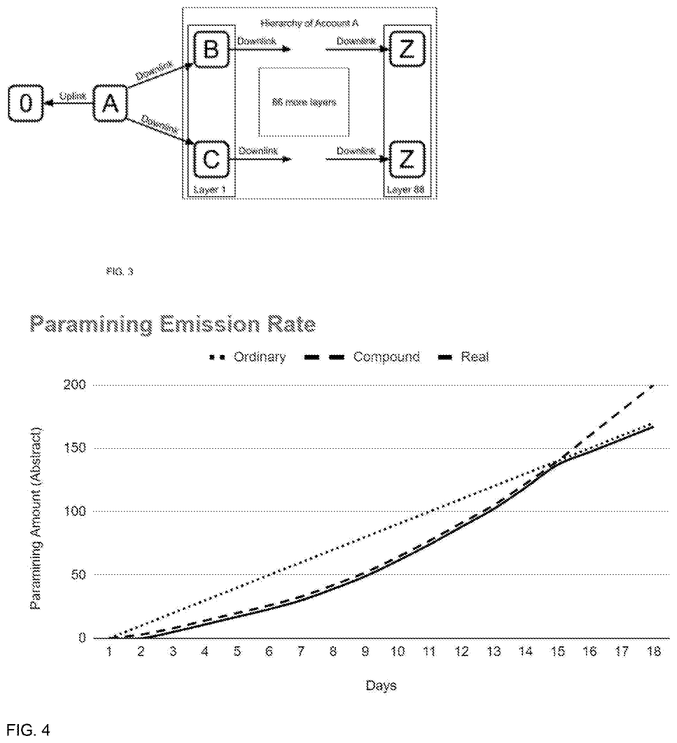

Example 4. The following example provides a more abstract demonstration of how the OPA and CPA formulas relate to one another and how a real paramining emission rate (i.e. paramining amount) is determined. See FIG. 4 as a visual guide to the below explanation.

The real paramining curve for a given account is determined as the lowest combined portions of two curves, the two curves being created, respectively, by the OPA and CPA formulas. In the graph provided in FIG. 4, the real paramining curve for the exemplary account is the combination of the CPA curve until its intersection with the OPA curve, both curves at the intersection, and the OPA curve after the intersection. This combination of the two curves comprises the lowest of the two values for the account at any single point in time.

Holds. A hold is designed to further protect an account from unwanted interruptions of paramining. A hold prevents a user account's balance from changing, even when an otherwise balance-changing event is thought to occur. The hold thus prevents a triggered paramining emission, which would otherwise occur due to, e.g., a newly forged block, an incoming transaction, or some other balance-changing event initiated by a user other than the account holder.

An account is placed on a hold (i.e. hold status) at blockchain height H if that account has (1) created a block at a time in the past and (2) the created block's height is within a predetermined range of blocks below the blockchain height H. If such a block is created, then any incoming transaction or reward for that block's creation is credited to the temporary balance of the account holder without interrupting the paramining process, without resetting paramining amount, and without changing T₀ in the CPA/OPA formulas. In such a case, the amount of the account's balance minus the temporary account's balance is used to calculate the paramining amount. An account receives all tokens held in the temporary balance, said held tokens being added to the account balance when the user makes any outgoing transaction. Such an outgoing transaction, signed by the account holder, serves as a confirmation of the account holder's willingness to trigger a paramining emission, transfer the temporary balance to the account's balance, update T₀, and begin the paramining process with a new account balance. In the next block created by any account on the blockchain, the paramining amount will also be credited to that account's balance via a paramining emission, after which T₀ in both OPA and CPA formulas will be set to the timestamp of the latest outgoing transaction.

OPA/CPA Dual Values and Holds, in general. As shown in FIG. 4, paramining amounts according to the OPA curve are beneficial for users over paramining amounts according to the CPA curve, until the intersection point, P, of the two curves. The intersection point is the best time option to trigger a paramining emission if paramining amount is calculated via the ordinary formula. If a user triggers a paramining emission at a point prior to the intersection time, i.e., inside the area between OPA and CPA curves, that user creates CPA(DAYS) amount of tokens, rather than the higher OPA(DAYS) amount that would be based solely on the OPA curve. This way, the combined used of the CPA curve decreases an amount of preemptively triggered paramining emissions, while smoothly allowing for systems to reach the intersection point, P. The “hold” further allows a user to receive transactions and forge blocks, which changes that user's balance but does not trigger a paramining emission. That user instead waits until the system reaches point, P, to trigger a paramining emission, in order to achieve the maximum possible paramining amount.

Example 5. The following example illustrates an exemplary chain of events occurring within and/or to an account.
1. An account has N tokens which the account received in a transaction at time, T₀;
2. Said N tokens on the account's balance generates K virtual tokens every 24 hours, and according to OPA/CPA (where ΔT−T₀=24 hours=86,400 seconds);
3. The account's paramining amount, K, is calculated as described herein;
4. At least 24 hours after a first incoming transaction, said first incoming transaction transferring the N tokens to the account, the account user sends a message to another user on the blockchain, paying a fee, F, for sending the message. Due to the fee payment, the account balance changes again.
5. The balance change event due to the fee payment is the paramining trigger for the creation of the K tokens (from virtual form into real form), where K is calculated via the OPA/CPA formulas described herein, i.e., in order for the K tokens to be emitted into the real blockchain. The K tokens are transferred from the genesis account to the user's account after the next block forged by any linked account and once a confirmation of the message transaction is received. The amount, K, is calculated based on the account balance N, but disregarding the fee, F, that was paid in the previous block. The next paramining amount may then be calculated based on the new account balance, i.e., N−F+K.

The specific events causing a paramining emission will depend on the particular blockchain implementation.

The following paramining triggers might occur within a particular blockchain:
1. Outgoing transaction—tokens spent, lowering the account balance.
2. Incoming transaction—tokens received, raising the account balance.
3. Block forged—reward tokens received by an account for forging a block, raising the account balance of the forger, and lowering account balances of those users paying fees for varying actions on the blockchain, said fees forming the reward to the forger.

Based on the above description, a resulting and novel advantage of the technology of the present invention is that it does not require users to engage in either forging of blocks or mining of tokens to be able to profit from stored tokens.

Providing a Defense Against 51% Attacks.

51% attacks allow attackers having a majority control of a network to interrupt the recording of new blocks by preventing other users from completing blocks. The present invention provides a solution to the problems relating to concentrating more than 51% of tokens in one account by making paramining emissions simultaneously to all token holder accounts (i.e. all accounts with a positive account balance).

51% attacks are made impossible for at least the following features of the present invention:
1. Paramining emission is independent from emissions occurring from forging and mining. As a result of such independence, the share of the total number of tokens entering the accounts of forging attackers decreases.
2. Paramining emission is distributed between all system users, continuing to reduce the share of attackers' tokens, and diluting the attackers' share in the total amount of funds.
3. Even having seized control of more then 50% of the tokens in the system, attackers will further require time to complete their attack. During this time, the attackers risk losing their advantage because paramining emissions continue to occur. Furthermore, the attackers are forced to buy more tokens to achieve enough PoS-power, essentially making the attack unprofitable because of the extra funds spent buying said PoS-power.
4. Most users of the system of the present invention who own a significant number of tokens will preferably distribute their funds across multiple accounts, in order to increase the paramining amount based on the account multipliers described hereinabove. Consequently, if attackers attempt to seize most of the system's funds via fraud, they will be forced to steal the keys to a significantly larger number of accounts. This requirement increases the complexity of such an operation and reduces the likelihood of its success, the reduction being directly proportional to the number of additional accounts.
5. Holds encourage users to take on an active part in maintaining the network, thus increasing the number of forging accounts and further complicating the performance of such an attack.

Example 6. The following example illustrates the defense against 51% attacks.

Account (A) receives the maximum token generation speed since additional wallet (i.e. linked account) balances are taken into account based on the account's structural factor. Multi-level (i.e. multi-layer) connections between accounts are formed at the time of the first transaction by a new wallet/account. The defense causes a change in the account multipliers by creating links between accounts at the time of their activation. A higher amount of linked accounts in turn leads to a greater hierarchy amount, which in turn leads to a higher account multiplier. The resulting higher account multiplier in turn leads to a higher allowed paramining amount per day for that account.

Using the system of account multipliers that modulate an account's rate of generating tokens, based on the user account's hierarchy amount, the present invention makes it very difficult to obtain more than 50% of the total tokens issued in one account, since tokens are emitted to all accounts having a positive balance (within predefined limits, as exemplified in Table 2). Due to the predefined limits, accounts with dangerously large hierarchy amounts do not generate new tokens via paramining (i.e. the multiplier is zero), which further decreases the relative PoS power an attacker may have with each new block that is created. This feature shows its maximum effectiveness when the initial tokens are distributed properly among anonymous investors after an ICO.

Within the scope of the invention is firmware, hardware, software and computer readable-media including software which is used for carrying out and/or guiding the methodologies described herein, particularly with respect to radioactive (and nuclear) threat detection. Hardware optionally includes a computer, the computer optionally comprising a processor, memory, storage space and software loaded thereon. The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. When used in the following claims, the terms “comprise(s)”, “include(s)”, “have” and their conjugates mean “including but not limited to”. The scope of the invention is limited only by the following claims.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A computer-implemented method for managing cryptocurrency, comprising:
providing user accounts to a plurality of users, each one of said user accounts being suitable for storing cryptocurrency tokens, each one of said user accounts initiating with a zero balance of cryptocurrency tokens,
providing a genesis account, said genesis account generating a plurality of cryptocurrency tokens,
responsive to a balance-changing event in any one of said user accounts, providing a paramining emission, said paramining emission causing a distribution of an amount of cryptocurrency tokens present within said genesis account at a time of said balance-changing event,
said distribution comprising paramining amounts per user account, said paramining amounts being calculated individually for each one of said user accounts, each of said paramining amounts being calculated using two multiplied values, said two multiplied values comprising an account balance multiplier and a hierarchy amount multiplier,
wherein each one of said user accounts receives a paramining amount equal to each one of said user accounts' balances multiplied by said two multiplied values, wherein all paramining amounts combine to equal said generated plurality of cryptocurrency tokens.

2. The method of claim 1, wherein said paramining amounts per user account are paramining amounts per user account over a period of time, wherein said period of time is 24 hours.

3. The method of claim 1, wherein said account balance multiplier is between 0.1 and 0.4.

4. The method of claim 1, wherein said hierarchy amount multiplier is between 2.0 and 4.0.

5. The method of claim 1, the method further comprising:
providing a paratax, said paratax being applied to each one of said user accounts' paramining amounts, said paratax being calculated by dividing a cryptocurrency's current emission by said cryptocurrency's maximum emission.

6. The method of claim 2, wherein said paratax is applied only to those ones of said user accounts located at a given blockchain height.

7. The method of claim 1, wherein each of said user accounts' paramining amounts is further calculated using data comprising:
a timestamp of a most recent account balance-changing event,
a current timestamp, and
a paratax associated with said user account.

8. The method of claim 1, wherein each of said user accounts' paramining amounts comprises dual preliminary values, a smaller one of which is provided as an account's true paramining amount.

9. The method of claim 7, wherein said dual preliminary values comprise an ordinary paramining amount (OPA) and a compound paramining amount (CPA).

10. The method of claim 8, wherein said OPA is calculated via the following relationship:
OPA=(user account balance*days*account multiplier)−paratax,
wherein days=ΔT/86,400,
wherein ΔT=T−T₀,
wherein T=a current time in seconds, and
wherein T₀=a timestamp of a most recent balance-changing event.

11. The method of claim 9, wherein said CPA is calculated via the following relationship:
CPA=(user account balance*((1+compound multiplier)^{periods})−account balance)−(2*paratax),
wherein compound multiplier=(account multiplier/(86,400/period duration),
wherein periods=ΔT/a period duration, and
wherein ΔT=T−T₀.

12. The method of claim 1, further comprising:
providing a hold, said hold being placed on a user account when:
said user account creates a block, and
said block's height is within a predetermined range below a given blockchain height,
said hold storing any incoming transaction for said block's creation in a temporary balance of said user account.

13. The method of claim 11, wherein said hold is removed when said user account makes an outgoing transaction, and wherein a transfer of the temporary balance to said user account's balance.

14. The method of claim 1, wherein each one of said user accounts further comprises a hierarchy amount, said hierarchy amount comprising a combination of balances of downlinked accounts.

15. The method of claim 13, wherein each of said user accounts comprises up to 88 layers of downlinked accounts.

16. The method of claim 14, wherein each layer of said up to 88 layers comprises two or more separate downlinked accounts.

17. The method of claim 1, wherein every paramining emission occurs without a fee payment.

18. The method of claim 1, wherein each user account comprises exactly one uplink.

19. A system for managing cryptocurrency, the system including a memory for storing computer-readable program code and a processor for executing the computer-readable program code, the system comprising:
a platform for providing user accounts to a plurality of users, each one of said user accounts being suitable for storing cryptocurrency tokens, each one of said user accounts initiating with a zero balance of cryptocurrency tokens,
a genesis account, said genesis account generating a plurality of cryptocurrency tokens for paramining emissions within said system,
a trigger for each of said paramining emissions, said trigger initiating each of said paramining emissions in response to a balance-changing event in any one of said user accounts, said paramining emission causing a distribution of an amount of cryptocurrency tokens present from said genesis account at a time of said balance-changing event,
a processor for determining portions of said distribution comprising paramining amounts per user account, said paramining amounts being calculated individually for each one of said user accounts, each of said paramining amounts being calculated using two multiplied values, said two multiplied values comprising an account balance multiplier and a hierarchy amount multiplier,
said processor further providing paramining amounts equal to each one of said user accounts' balances multiplied by said two multiplied values,
wherein all paramining amounts for the balance-changing event combine to equal said generated plurality of cryptocurrency tokens distributed from said genesis account.

20. A computer program product for managing cryptocurrency, the computer program product comprising a computer-readable medium having stored computer-readable program code for performing the steps of:
providing user accounts to a plurality of users, each one of said user accounts being suitable for storing cryptocurrency tokens, each one of said user accounts initiating with a zero balance of cryptocurrency tokens,
providing a genesis account, said genesis account generating a plurality of cryptocurrency tokens,
responsive to a balance-changing event in any one of said user accounts, providing a paramining emission, said paramining emission causing a distribution of an amount of cryptocurrency tokens present within said genesis account at a time of said balance-changing event,
said distribution comprising paramining amounts per user account, said paramining amounts being calculated individually for each one of said user accounts, each of said paramining amounts being calculated using two multiplied values, said two multiplied values comprising an account balance multiplier and a hierarchy amount multiplier,
wherein each one of said user accounts receives a paramining amount equal to each one of said user accounts' balances multiplied by said two multiplied values, wherein all paramining amounts combine to equal said generated plurality of cryptocurrency tokens.
